(19) United States
(12) Patent Application Publication
(10) Pub. No.: US 2013/0181632 A1
(43) Pub. Date: Jul. 18, 2013

(54) Flash Generating Device for LED and Flash Generating Method for LED

(71) Applicant: Weiming Chu, Tokyo (JP)

(72) Inventor: Weiming Chu, Tokyo (JP)

(73) Assignee: ASAHI KASEI MICRODEVICES CORPORATION, Tokyo (JP)

(21) Appl. No.: 13/823,842

(22) PCT Filed: Jan. 27, 2012
(86) PCT No.: PCT/JP2012/000545

§ 371 Date: Mar. 15, 2013

(30) Foreign Application Priority Data
Feb. 1, 2011 (JP) 2011-020209

(51) Int. Cl. H05B 37/02

(52) U.S. Cl. CPC H05B 37/02
USPC 315/224

(57) ABSTRACT

Provided is a flash generating device for an LED, which has a small energy loss and a small system area. A flash generating device (1) is provided with: an input power supply (VIN) ; a large capacity capacitor (20); a step-down circuit (10) that is coupled between the input power supply (VIN) and one terminal of the large capacity capacitor; a step-up circuit (30) that is coupled between the one terminal of the large capacity capacitor and one terminal of the LED; and a constant current source (120) that is coupled between the other terminal of the LED and ground. An inductive element (L) whose one terminal is coupled to the large capacity capacitor, and a second transistor (M2) whose one terminal is coupled to the inductive element (L) and another terminal is coupled to the ground are shared constituent elements of both of the step-down circuit and the step-up circuit.

### TECHNICAL FIELD

The present invention relates to a flash generating device for an LED and a flash generating method for an LED. More particularly, the present invention relates to a flash generating device and flash generating method that charge a large capacity capacitor from a power supply and generate a flash of an LED by electrically stored energy.

### BACKGROUND ART

Patent Literature 1 discloses a flash light emitting device for an LED. With reference to FIG. 1, a main part illustrated in FIGS. 6 and 7 of Patent Literature 1 is schematically described. A large capacity capacitor 920 is charged with energy stored in a battery through a constant current/constant voltage charging circuit 910, and the energy stored in the large capacity capacitor 920 is stepped up by a flash LED stepping-up constant current circuit 930. The stepped up energy is supplied to the LED serving as a load.

### CITATION LIST

### Patent Literature

PTL1: Japanese Patent Laid-Open No. 2007-121755

### SUMMARY OF INVENTION

### Technical Problem

In a technique described in Patent Literature 1, the large capacity capacitor 920 is charged by the constant current/constant voltage charging circuit 910. For this reason, if a charge voltage of the large capacity capacitor 920 is low, an energy loss occurring in the constant current/constant voltage charging circuit 910 becomes large. Specifically, in the case where a voltage of the battery is 3.7 V; the charge voltage of the large capacity capacitor 920 is 1 V; and a current of the constant current/constant voltage charging circuit 910 is 0.5 A, the loss occurring in the constant current/constant voltage charging circuit 910 is (3.7−1)×0.5=1.35 W.

Also, both of the constant current/constant voltage charging circuit 910 and the flash LED stepping-up constant current circuit 930 are required, and therefore an increase in a system area, and the like, are unavoidable.

The present invention is made in consideration of such a problem, and an object thereof is to provide a flash generating device for an LED, which has a small energy loss and also a small system area where a circuit is formed.

### Solution to Problem

One aspect of the present invention is a flash generating device for an LED, and the flash generating device for an LED is provided with: an input power supply; a capacitor; an inductive element that is coupled to the capacitor; and a switching circuit, wherein after forming a path from the input power supply to the inductive element and the capacitor to step down energy of the input power supply, the switching circuit charges the capacitor with the stepped down energy, and after forming a path from the capacitor and the inductive element to the LED to step up the energy with which the capacitor is charged, the switching circuit outputs the stepped up energy to the LED.

The switching circuit has first, second, third, and fourth terminals; the input power supply is coupled to the first terminal; the inductive element is coupled between the capacitor and the second terminal; the LED is coupled to the third terminal; the fourth terminal is coupled to ground; the switching circuit forms a first path between the first terminal and the second terminal, forms a second path between the second terminal and the fourth terminal, and forms a third path between the second terminal and the third terminal; and the inductive element, the first path, and the second path can constitute a step-down circuit, and the inductive element, the second path, and the third path can constitute a step-up circuit.

Preferably, the switching circuit can make the first path and the second path complementarily conductive to perform step-down operation together with the inductive element, and make the second path and the third path complementarily conductive to perform step-up operation together with the inductive element.

Further, the switching element can also block the third path while performing the step-down operation, and while performing the step-up operation, block the first path.

Preferably, the second path can include a transistor that is coupled between the inductive element and the ground.

Also, the first path can include a transistor that is coupled between the first terminal and the second terminal.

Further, the third path can include a diode that is coupled between the second terminal and the third terminal.

Another aspect of the present invention is a flash generating method for an LED, and the flash generating method for an LED is provided with the steps of: after forming a path from an input power supply to an inductive element, and further to a capacitor coupled to the inductive element to step down energy of the input power, charging the capacitor with the stepped down energy; and after forming a path from the capacitor and the inductive element to the LED to step up the energy with which the capacitor is charged, outputting the stepped up energy to the LED.

Also, a still another aspect of the present invention is a flash generating device for an LED, and the flash generating device for an LED is provided with: an input power supply; a capacitor; a step-down circuit that is coupled between the input power supply and one terminal of the capacitor, and includes an inductive element whose one terminal is coupled to the capacitor; and a step-up circuit that is coupled between the one terminal of the capacitor and one terminal of the LED, and includes the inductive element, wherein the inductive element is a constituent element of both of the step-down circuit and the step-up circuit.

Further, a yet another aspect of the present invention is a flash driving circuit for an LED, and the flash driving circuit for an LED is provided with: a control circuit; a first transistor whose switching is controlled by a drive signal outputted by the control circuit; a constant current source that is coupled between the control circuit and ground; a first terminal that is provided at one terminal of the first transistor and that makes a coupling to an input power supply; a second terminal that is provided at another terminal of the first transistor and that makes a coupling to a step-up circuit; a third terminal that controls switching of a second transistor by a drive signal; and a fourth terminal that couples the constant current source to the LED, wherein an inductive element whose one terminal is coupled to a capacitor, and the second transistor whose one terminal is coupled to the inductive element and another terminal is coupled to the ground are part of the step-up circuit.

### Advantageous Effects of Invention

In the flash generating device according to the present invention, one and the same inductive element can be set as a constituent element of both of the step-down circuit and the step-up circuit. This enables a system area to be significantly reduced as compared with the conventional flash generating device in which the constant current/constant voltage charging circuit and the step-up circuit are respectively independently present. Further, in the flash generating device according to the present invention, the large capacity capacitor is charged from the input power supply through the step-down circuit. For this reason, an energy loss can be suppressed as compared with the conventional flash generating device in which the large capacity capacitor is charged through the constant current/constant voltage charging circuit.

### BRIEF DESCRIPTION OF DRAWINGS

FIG. 1 is a diagram illustrating a configuration of a conventional flash light emitting device;

FIG. 2 is a diagram illustrating a configuration of a flash generating device for an LED according to the present invention;

FIG. 3 is a diagram illustrating a configuration of a flash generating device for an LED according to one embodiment of the present invention;

FIG. 4 is a diagram illustrating a configuration example of a control circuit of the flash generating device for an LED according to one embodiment of the present invention;

FIG. 5 is a diagram for describing operation (at the time of charging) of the flash generating device for an LED according to one embodiment of the present invention;

FIG. 6 is a diagram for describing the operation (at the time of charging) of the flash generating device for an LED according to one embodiment of the present invention;

FIG. 7 is a diagram for describing operation (at the time of discharging) of the flash generating device for an LED according to one embodiment of the present invention; and

FIG. 8 is a diagram for describing the operation (at the time of discharging) of the flash generating device for an LED according to one embodiment of the present invention.

### DESCRIPTION OF EMBODIMENTS

In the following, an embodiment of the present invention is described with reference to drawings.

### <Flash Generating Device>

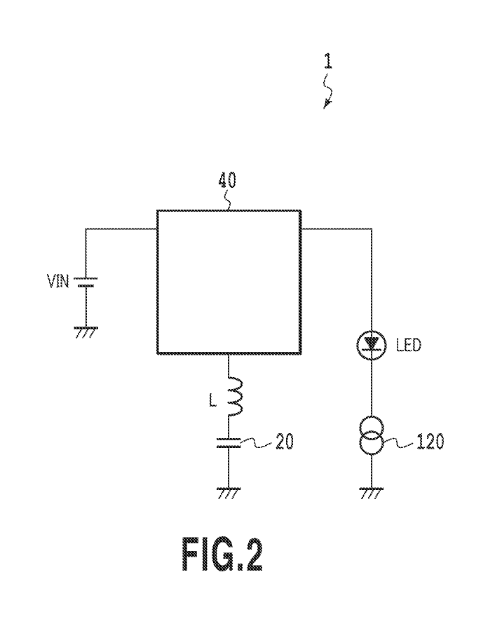

FIG. 2 is a diagram illustrating a configuration of a flash generating device for an LED of the present invention.

A flash generating device I is provided with an input power supply VIN, a large capacity capacitor 20, an inductive element L that is coupled to the large capacity capacitor 20, and a switching circuit 40. The switching circuit 40 forms a path depending on step-down or step-up operation as follows: A path (first path) from the input power supply VIN to the inductive element L and large capacity capacitor 20 is formed to step down energy of the input power supply VIN. The large capacity capacitor 20 is charged by a stepped down voltage. Also, a path (second path) from the large capacity capacitor 20 and inductive element L to the LED is formed to step up energy with which the large capacity capacitor 20 is charged. After the step-up, the energy is outputted to the LED.

The LED is coupled to the switching circuit 40 at one terminal thereof, and to a constant current source 120 at the other terminal thereof.

When performing the step-down operation, the switching circuit 40 forms the path (first path) from the input power supply VIN to the inductive element L and large capacity capacitor 20; inputs the energy of the input power supply VIN to the inductive element L to step down the energy; and charges the large capacity capacitor 20 with the stepped down energy.

Also, when performing the step-up operation, the switching element 40 forms the path (second path) from the large capacity capacitor 20 and the same inductive element L as that used for the step-down operation to the LED; inputs the energy electrically stored in the large capacity capacitor 20 to the inductive element L to step up the energy; and outputs the stepped up energy to the LED.

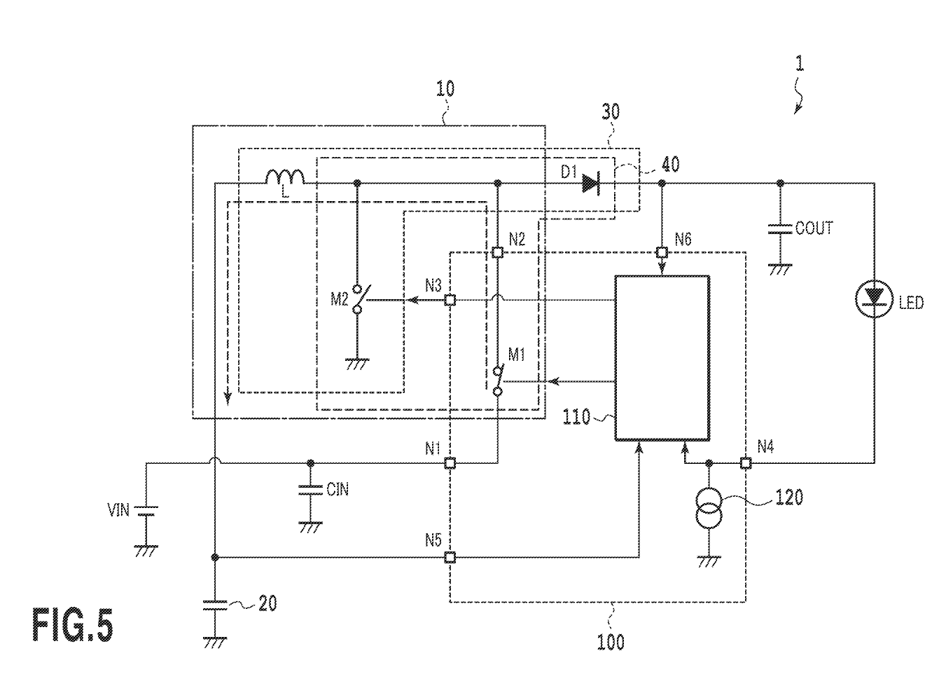

Here, note that the formation of the paths by the switching circuit 40 means not only the static formation of DC-wise paths but also the formation of paths that respectively enable the energies related to the inductive element L to be transmitted. As will be described later in detail along with FIGS. 5 to 8, in the flash generating device of the present invention, the inductive element L functions as part of a DC/DC converter, and therefore part of the above-described paths operates so as to repeat on/off. Accordingly, the above-described paths also operate so as to intermittently open/close.

In the flash generating device 1, the switching circuit 40 forms the paths that can bi-directionally set a direction of energy to be inputted to the inductive element L as described. Such a configuration of the switching circuit 40 enables both of the step-down operation and step-up operation to be performed with use of the one inductive element L. For this reason, one shared circuit element can be used to perform the two different types of operation, and therefore an effect capable of reducing a system area is produced.

The flash generating device of the present invention uses the inductive element to perform the step-down operation and step-up operation, and has a low loss, so that the flash generating device can also reduce an energy loss.

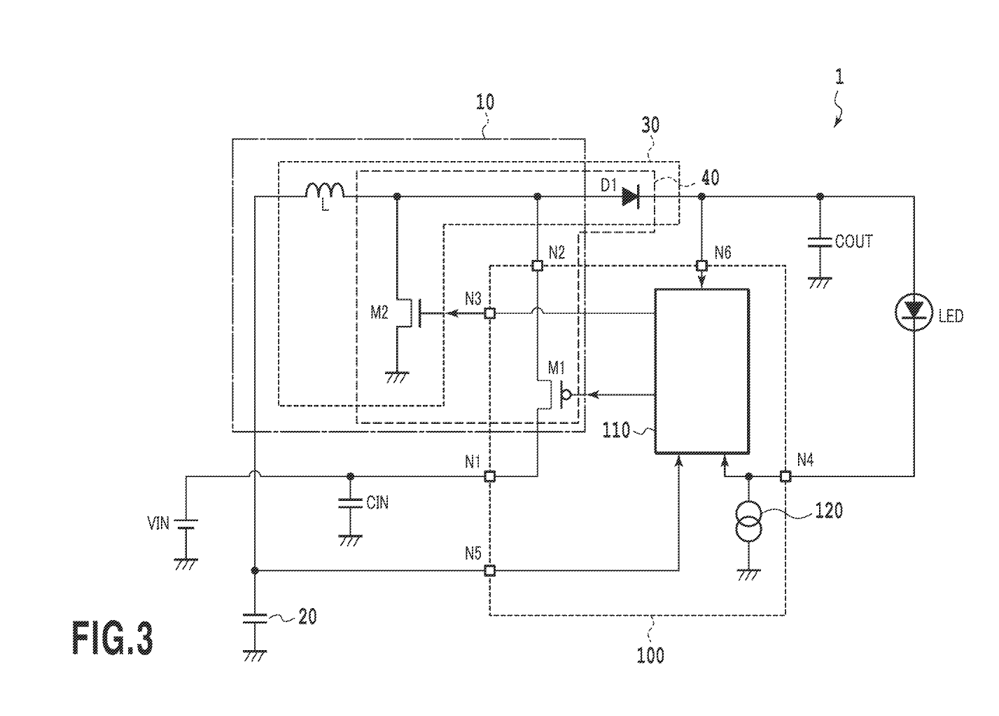

FIG. 3 is a diagram illustrating a configuration of a flash generating device for an LED according to one embodiment of the present invention.

In a flash generating device 1 in FIG. 3, an inductive element L; in a switching circuit 40, a path from an input power supply VIN to the other terminal (terminal on a side opposite to a large capacity capacitor 20) of the inductive element L; and a path from the other terminal of the inductive element L to ground constitute a step-down circuit 10.

Also, in the flash generating device 1, the inductive element L; in the switching circuit 40, the path from the other terminal of the inductive element L to the ground; and a path from the other terminal of the inductive element L to the LED constitute a step-up circuit 30.

In the flash generating device 1, the path between the input power supply VIN and the other terminal of the inductive element L is formed to input energy from the input power supply VIN to the inductive element L, and the large capacity capacitor 20 is charged with the energy. Also, in the flash generating device 1, the inductive element L is charged with the energy with which the large capacity capacitor 20 is charged, and the path between the other terminal of the inductive element L and the LED is formed to discharge the energy to the LED.

As described, in the flash generating device 1 of the present embodiment, the path (first path) for inputting the energy from the input power supply VIN to the inductive element L, and the path (second path) for outputting the energy from the inductive element L to the LED are formed. Between when the energy is electrically stored in the large capacity capacitor 20 and when the energy is discharged from the large capacity capacitor 20, a direction of current flowing through the inductive element L is opposite. This enables the inductive element L to be shared as one constituent element having functions for both of the step-down circuit 10 and the step-up circuit 30. The one shared element can be used to perform the different functions, and therefore the system area can be reduced.

The flash generating device of the present invention employs the inductive element for the step-down circuit 10, and has a low loss, so that the flash generating device can also reduce the energy loss.

Also, in the flash generating device 1 according to the present embodiment, between the input power supply VIN and the other terminal (terminal on the side opposite to the large capacity capacitor 20) of the inductive element L, a first transistor M1 is coupled to configure the path between the input power supply VIN and the other terminal of the inductive element. Also, between the other terminal of the inductive element L and the ground, a second transistor M2 is coupled to configure the path between the other terminal of the inductive element L and the ground. Further, between the other terminal of the inductive element L and the LED, a diode D1 is coupled to configure the path between the other terminal of the inductive element L and the LED. As described above, on/off of the two transistors M1 and M2 can be used to make selective conduction between the input power supply VIN and the other terminal of the inductive element L, between the other terminal of the inductive element L and the ground, or between the inductive element L and the LED.

In the above-described configuration, by coupling the second transistor M2 between the other terminal of the inductive element L and the ground, the second transistor M2 can be shared as a constituent element of both of the step-down circuit 10 and the step-up circuit 30. By sharing the second transistor M2 in addition to the inductive element L, the system area can be further reduced.

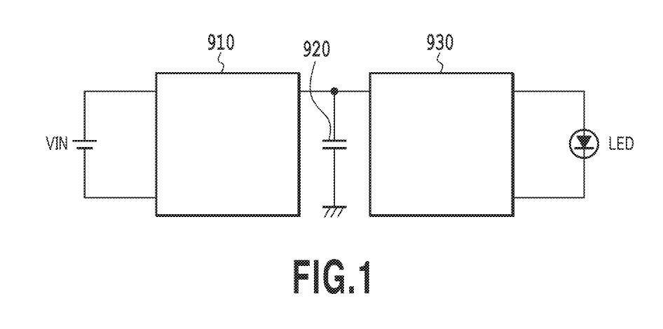

As compared with the flash generating device according to the conventional technique, in which the constant current/constant voltage charging circuit 910 and the step-up circuit 930 illustrated in FIG. 1 are respectively independently configured, the flash generating device 1 of the present invention enables the system area to be further significantly reduced.

In addition, the flash generating device 1 according to the present embodiment is also provided with a flash driving circuit 100 for charging/discharging the large capacity capacitor 20. Although a configuration is different, the flash light emitting device in Patent Literature 1 is also the same in terms of (inside the constant current/constant voltage charging circuit 910) being provided with a control circuit E for charging/discharging the large capacity capacitor 920. The configuration in which the inductive element L and also the second transistor M2 are shared, which is specific to the present embodiment, enables an area for circuit components constituting the system to be significantly reduced as compared with the conventional technique.

In the flash generating device I according to the present embodiment, in the step-down circuit 10, the first transistor M1 and the second transistor M2 are respectively a P-channel MOS transistor and an N-channel MOS transistor, but may be respectively an N-channel MOS transistor and a P-channel MOS transistor. In this case, polarities of drive signals given to gates of the first transistor M1 and second transistor M2 are opposite to each other.

Also, in the flash generating device 1 according to the present embodiment, in the step-up circuit 30, in the path between the other terminal of the inductive element L and the LED, the diode Dl is coupled. However, without limitation to the diode D1, a transistor may be coupled. In this case, a drive signal that turns off the transistor replacing the diode D1 when the step-down circuit 10 operates, and turns on/off the transistor complementarily with the second transistor M2 when the step-up circuit 30 operates may be provided to each gate.

Although details will be described later, the flash generating device 1 illustrated in FIG. 3 charges the large capacity capacitor 20 from the input power supply VIN through the step-down circuit 10. For this reason, as compared with the conventional flash generating device that charges the large capacity capacitor 920 through the constant current/constant voltage charging circuit 910, the energy loss can be suppressed.

In the present description, the “large capacity capacitor” refers to a capacitor having a large capacitance value, such as an electrical double layer capacitor, super capacitor, or ultra capacitor, and is preferably a capacitor having a capacitance value not less than 0.1 F and not more than 10000 F.

Also, the description has been provided with the example where between the other terminal of the LED and the ground, the constant current source 120 is coupled; however, the LED can also be driven by a constant voltage. In the case of driving the LED by a large current, in order to prevent a current equal to or more than a recommended maximum current for the LED from flowing to shorten a life, constant current drive is preferable.

### <Flash Driving Circuit>

Next, a configuration and operation of the flash driving circuit 100 are described. The flash driving circuit 100 is provided with: a control circuit 110; the first transistor M1 whose switching is controlled by a drive signal outputted by the control circuit 110; and the constant current source 120 that is coupled between the control circuit 110 and the ground. In addition, the flash driving circuit 100 is provided with six terminals described below. That is, the flash driving circuit 100 is provided with: a first terminal N1 that is provided at one terminal of the first transistor M1 and intended to make a coupling to the input power supply VIN; a second terminal N2 that is provided at the other terminal of the first transistor M1 and intended to make a coupling to t step-up circuit 30; a third terminal N3 that is intended to use a drive signal to control switching of the second transistor M2 that is the constituent element shared by the step-down circuit 10 and the step-up circuit 30; a fourth terminal N4 that is intended to couple the constant current source 120 to the LED; a fifth terminal N5 that is intended to couple the control circuit 110 to the large capacity capacitor 20 and feed back a voltage of the large capacity capacitor 20 to the control circuit 110; and a sixth terminal N6 that is intended to couple the control circuit 110 to the LED and feed back a voltage of the LED to the control circuit 110.

The flash generating device 1 has been described so far from the viewpoint that the step-down circuit 10 and the step-up circuit 30 include the same shared transistor (specifically, the second transistor M2) and inductive element (specifically, the inductive element L) as their constituent elements. However, the description can also be provided from another viewpoint. The step-down circuit 10 can also be considered to have a configuration in which the second transistor M2 and inductive element L, which are part of the step-up circuit 30, are added with the first transistor Ml.

In the flash generating device 1, the step-down circuit 10 operates as a step-down type DC/DC converter by a drive signal from the control circuit 110 of the flash driving circuit 100. Further, the step-up circuit 30 operates as a step-up type DC/DC converter by a different drive signal from the control circuit 110 of the flash driving circuit 100.

On the basis of such a configuration and operation of the flash generating device, the flash driving circuit 100 can make the step-up circuit 30 operate. Further, the flash driving circuit 100 can make operate the step-down circuit 10 that is configured to include the inductive element L and second transistor M2, which are part of the step-up circuit 30, and the first transistor M1.

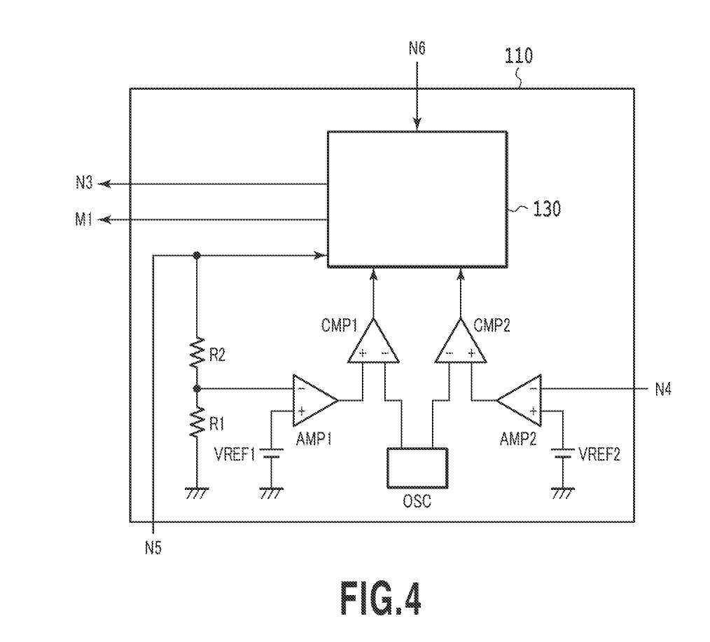

FIG. 4 is a diagram illustrating a configuration example of the control circuit 110 of the flash generating device for an LED according to one embodiment of the present invention.

The control circuit 110 is coupled in series between the fifth terminal N5 and the ground, and provided with: resistors R1 and R2 that divide the voltage of the large capacity capacitor 20 to output the divided voltage from a common coupling part; an error amplifier circuit AMP1 that amplifies a difference between the divided voltage and a reference voltage VREF1 to output an error voltage; an oscillating circuit OSC that outputs a triangular wave; a comparator circuit CMP1 that compares the error voltage outputted by the error amplifier circuit AMP1 and the triangular wave with each other to output a PWM signal; an error amplifier circuit AMP2 that amplifies a difference between a voltage at the fourth terminal and a reference voltage VREF2 to output an error voltage; a comparator circuit CMP2 that compares the error voltage outputted by the error amplifier circuit AMP2 and the triangular wave to output a PWM signal; and a drive circuit 130 that is inputted with the voltage of the large capacity capacitor 20, output voltage, PWM signals outputted by the comparator circuits CPM1 and CMP2, and outputs the drive signals that respectively control the switching of the first and second transistors M1 and M2.

The reference voltage VREF1 is a voltage corresponding to a desired voltage of the large capacity capacitor 20, and the reference voltage VREF2 corresponds to a desired output voltage, and is a voltage for applying an appropriate bias voltage to the LED

The PWM signal outputted by the comparator circuit CMP1 is a signal for stepping down the input power supply VIN, and the PWM signal outputted by the comparator circuit CMP2 is a signal for stepping up the voltage of the large capacity capacitor 20.

When the voltage of the input power supply VIN is stepped down to charge the large capacity capacitor 20, the drive circuit 130 selects the PWM signal outputted by the comparator circuit CMP1, and outputs the PWM signal to the first and second transistors M1 and M2. At this time, the first and second transistors M1 and M2 are complementarily turned on/off according to a duty of the PWM signal.

When the voltage of the large capacity capacitor 20 is stepped up to output the output voltage to the LED, the drive circuit 130 selects the PWM signal outputted by the comparator circuit CMP2 to output the PWM signal to the second transistor M2, and outputs a high level signal to the first transistor M1. At this time, the second transistor M2 is turned on/off according to a duty of the PWM signal. The first transistor M1 is a P-channel MOS transistor and inputted with the high level signal, and is therefore turned off.

The drive circuit 130 monitors the voltage of the large capacity capacitor 20 through the fifth terminal N5, and if charge voltage of the capacitor 20 is lower than a desired charge level, selects the PWM signal outputted by the comparator circuit CMP1 such that the step-down operation is performed. Further, the drive circuit 130 also performs control such that the voltage of the large capacity capacitor 20 does not exceed a breakdown voltage. Also, the drive circuit 130 selects the output voltage of the comparator circuit CMP2 to monitor a cathode voltage of the LED at the fourth terminal N4, and performs control so as to, if the voltage is lower than the reference voltage VREF2, increase the output voltage, and if the voltage is higher than the reference voltage VREF2, perform the step-up operation while decreasing the output voltage. The drive circuit 130 monitors the output voltage through the sixth terminal N6, and at the time of overvoltage, turns off the first and second transistors M1 and M2 to stop the step-up operation.

### <Description of Operation>

With reference to FIGS. 5 to 8, an operation example of the flash generating device for an LED according to one embodiment of the present invention is described.

First, described is operation of charging the large capacity capacitor 20 with power from the input power supply VIN through the step-down circuit 10. In the case of the flash driving circuit 100 of FIG. 3, by complementarily turning on/off the first and second transistors M1 and M2, the input voltage is stepped down to charge the large capacity capacitor 20. In this case, the diode D1 is turned off because an inter-terminal voltage thereof is lower than a threshold value, and therefore the path between the other terminal of the inductive element L and the LED is blocked.

FIG. 5 is a diagram for describing operation of the flash generating device for an LED at the time of charging according to one embodiment of the present invention. As illustrated in FIG. 5, in the step-down circuit 10, the first transistor M1 is turned on and the second transistor M2 is turned off by the flash driving circuit 100. From the input power supply VIN, current flows to the large capacity capacitor 20 through the first transistor M1 and inductive element L to charge the inductive element L with energy. A path of the current at this time is indicated by a dashed arrow.

The step-down circuit 10 makes the path between the input power supply VIM and the inductive element L conductive, and blocks the path between the inductive element L and the ground to charge the inductive element L with the energy.

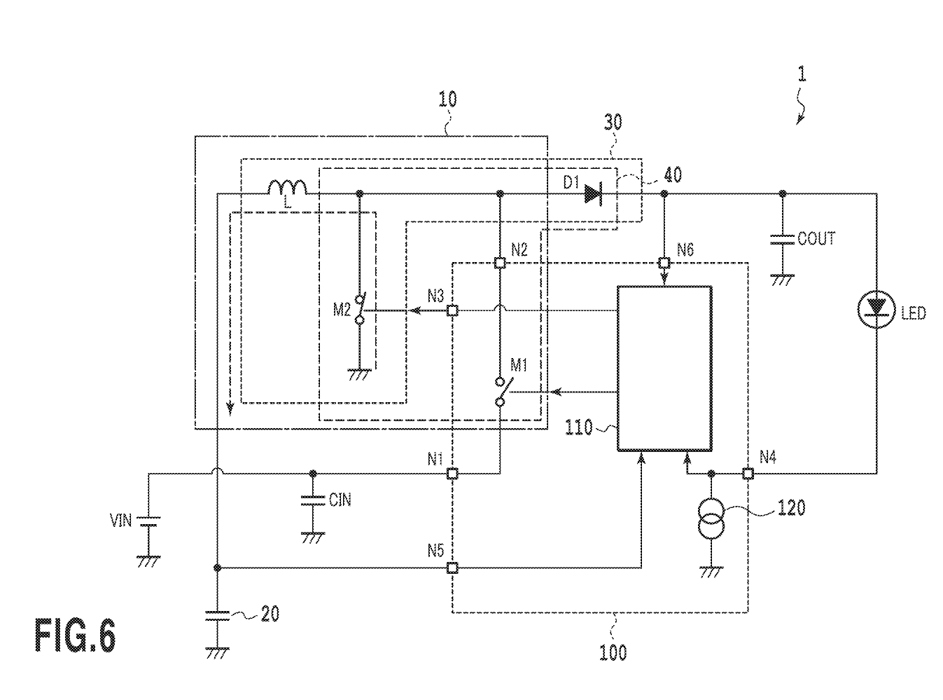

FIG. 6 is another diagram for describing the operation of the flash generating device for an LED at the time of charging according to one embodiment of the present invention. As illustrated in FIG. 6, in the step-down circuit 10, the first transistor M1 is turned off and the second transistor M2 is turned on by the flash driving circuit 100. Then, from the ground, current flows to the large capacity capacitor 20 through the second transistor M2 and inductive element L. A path of the current at this time is indicated by a dashed arrow.

In this case, the step-down circuit 10 blocks the path between the input power supply VIN and the inductive element L, and makes the path between the inductive element L and the ground conductive to charge the large capacity capacitor 20 with the energy electrically stored in the inductive element L.

The operation of complementarily turning on/off the first and second transistors M1 and M2 is repeated to alternately repeat the above-described states in FIGS. 5 and 6.

That is, the operation of making the path between the input power supply VIN and the inductive element L and the path between the inductive element L and the ground complementarily conductive is repeated. Energy charging/discharging of the inductive element L is repeated, and the large capacity capacitor 20 is charged with the energy obtained by stepping down the input power VIN.

Also, a charge state of the large capacity capacitor 20 is fed back from the fifth terminal N5 to the control circuit 110, and thereby when the large capacity capacitor 20 reaches a desired charge level, the switching of the first transistor M1 is stopped to terminate the charge operation.

The step-down circuit 10 uses the inductive element L to charge the large capacity capacitor 20 with the energy, and thereby the energy loss can be suppressed.

As described above, the flash generating device of the present invention charges the large capacity capacitor 20 through the step-down circuit 10 using the inductive element L, and thereby the energy loss is significantly reduced as compared with the conventional device using the constant current/constant voltage charging circuit 910. Specifically, in the case where the power supply voltage=3.7 V, an average current supplied from the input voltage VIN=0.5A, and efficiency of the step-down circuit 10=80%, the energy losses occurring at the time of charging by the constant current/constant voltage charging circuit 910 according to the conventional technique and by the step-down circuit 10 according to the present invention are as listed in Table 1 below:

TABLE 1

| | | | Energy loss (W) |
|---|---|---|---|
| | | | when using |
| Voltage (V) of | | Energy loss | constant |
| large | | (W) when using | current/constant |
| capacity | Total energy | step-down | voltage charging |
| capacitor | (W) | circuit | circuit |
| 0.1 | 1.85 | 0.37 | 1.8 |
| 0.5 | 1.85 | 0.37 | 1.6 |
| 1 | 1.85 | 0.37 | 1.35 |
| 2 | 1.85 | 0.37 | 0.85 |
| 2.5 | 1.85 | 0.37 | 0.6 |

(Note)
Total energy = Power supply voltage × Average current supplied from power supply
Loss when using constant current/constant voltage charging circuit = (Power supply voltage − Capacitor voltage) × Average current supplied from power supply
Loss when using step-down circuit = Total energy × (1 − Efficiency of step-down circuit)

From Table 1, it turns out that the flash generating device of the present invention has a significantly reduced energy loss.

Also, in the case of the conventional method, a charge current to the large capacity capacitor 920 is 0.5 A; however, in the case of the step-down circuit 10,

Charge current to large capacity capacitor=Average current supplied from power supply×Power supply voltage×Efficiency of step-down circuit/Large capacity capacitor voltage,

and therefore the charge current to the large capacity capacitor is as listed in Table 2 below:

TABLE 2

| | | When using constant |
|---|---|---|
| | When using | current/constant |
| Capacitor voltage | step-down circuit | voltage charging |
| (V) | (A) | circuit (A) |
| 0.1 | 14.80 | 0.5 |
| 0.5 | 2.96 | 0.5 |
| 1 | 1.48 | 0.5 |
| 2 | 0.74 | 0.5 |
| 2.5 | 0.59 | 0.5 |

That is, in the case where the average currents respectively supplied from the power supplies are the same, as compared with the conventional flash generating device that charges the large capacity capacitor 920 through the constant current/constant voltage charging circuit 910, the flash generating device 1 according to the present invention, which charges the large capacity capacitor 20 through the step-down circuit 10, can supply a larger amount of charge current to the large capacity capacitor 20. Accordingly, a charging time can also be significantly shortened.

Next, described is operation of using the step-up circuit 30 to step up the power electrically stored in the large capacity capacitor 20, and supplying the stepped up power to the LED serving as a load. In the case of the circuit illustrated in FIG. 3, by switching the second transistor M2 and turning off the first transistor Ml, the voltage of the large capacity capacitor 20 can be stepped up and supplied to the LED. At this time, the path between the input power supply and the other terminal of the inductive element L is blocked.

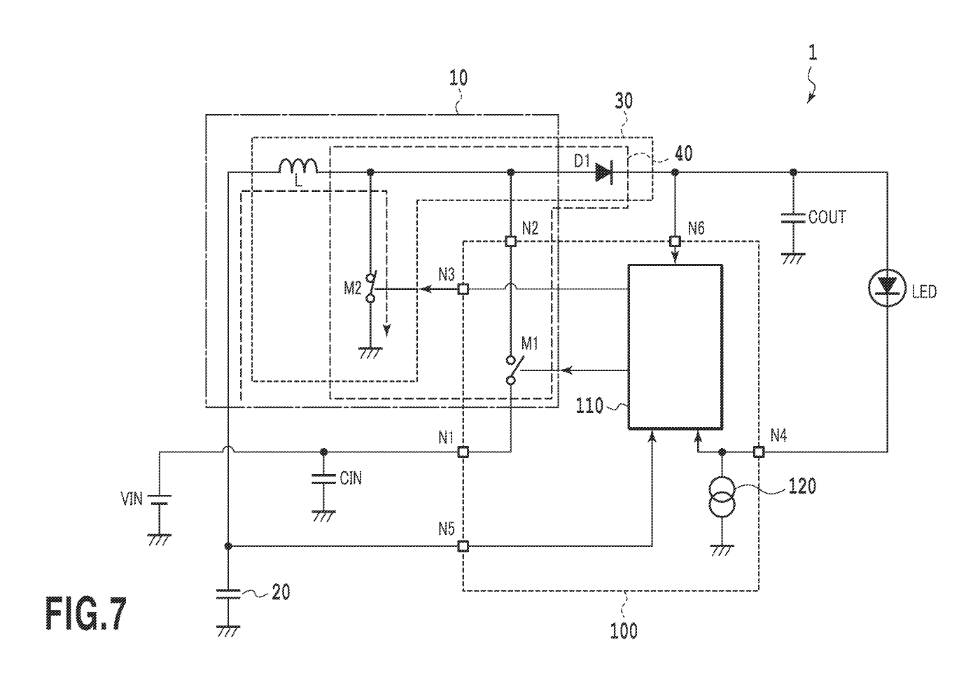

FIG. 7 is a diagram for describing operation of the flash generating device for an LED at the time of discharging according to one embodiment of the present invention. As illustrated in FIG. 7, in the step-up circuit 30, the second transistor M2 is turned on by the flash driving circuit 100. Then, from the large capacity capacitor 20, current flows to the ground through the inductive element L, and the inductive element L is charged with energy. A path of the current at this time is indicated by a dashed arrow. Also, at this time, energy stored in an output capacitor GOUT is discharged to the LED, and thereby current flows through the LED.

That is, the step-up circuit 30 makes the path between the inductive element L and the ground conductive to charge the inductive element L with the energy.

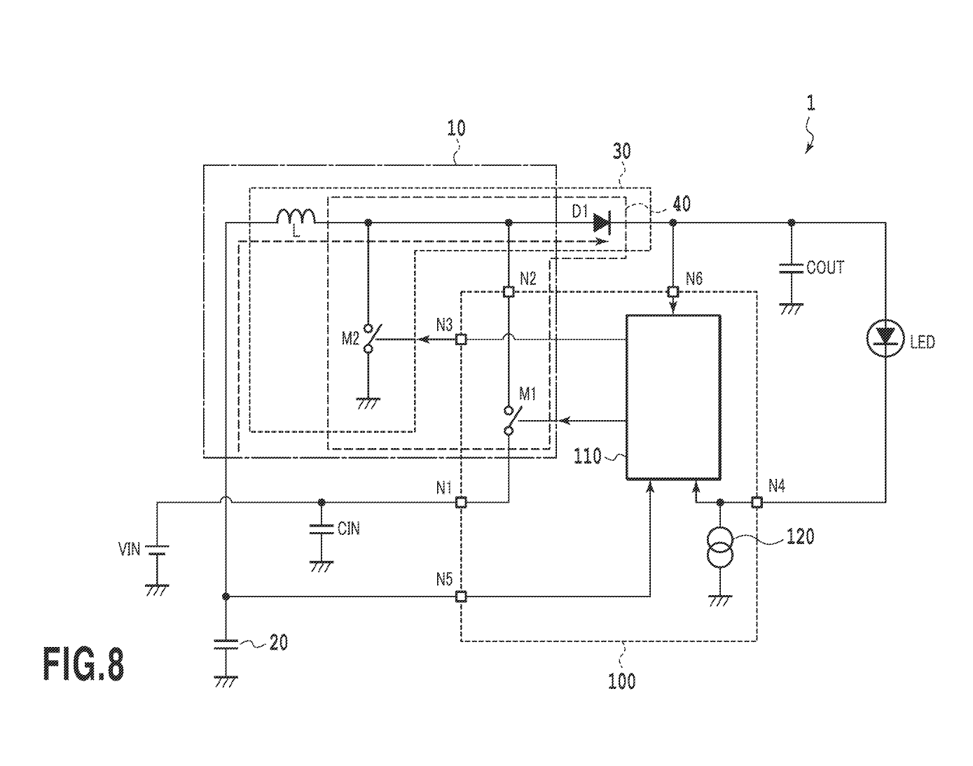

FIG. 8 is another diagram for describing the operation of the flash generating device for an LED at the time of discharging according to one embodiment of the present invention. As illustrated in FIG. 8, in the step-up circuit 30, the second transistor M2 is turned off by the flash driving circuit 100. Then, from the large capacity capacitor 20, current flows to the LED and output capacitor GOUT through the inductive element L and diode D1. A path of the current at this time is indicated by a dashed arrow.

That is, the step-up circuit 30 blocks the path between the inductive element L and the ground and makes the path between the inductive element L and the LED conductive, and thereby supplies the energy electrically stored in the inductive element to the LED.

The on/off operation of the second transistor M2 is repeated to alternately repeat the states of FIGS. 7 and 8.

That is, the operation of making conductive and blocking the path between the inductive element L and the ground is repeated to repeat energy charging/discharging of the inductive element L. Further, the LED is supplied with voltage obtained by stepping up the voltage of the large capacity capacitor 20, and thereby the LED generates a flash.

The flash generating device of the present invention has the above-described configuration and operation, and can thereby reduce the energy loss and also the system area.

### INDUSTRIAL APPLICABILITY

The present invention can be used for a flash generating device that generates a flash with an LED.

### Reference Signs List

1: Flash generating device

10: Step-down circuit

20: Large capacity capacitor

30: Step-up circuit

40: Switching circuit

100: Flash driving circuit

110: Control circuit

120: Constant current source

VIN: Input power supply

Ml: First transistor

M2: Second transistor

L: Inductive element

N1: First terminal

N2: Second terminal

N3: Third terminal

N4: Fourth terminal

N5: Fifth terminal

N6: Sixth terminal

R1, R2: Resistor

AMP1, AMP2: Error amplifier circuit

CMP1, CMP2: Comparator circuit

OSC: Oscillating circuit

130: Drive circuit

1. A flash generating device for an LED, the device comprising:
an input power supply;
a capacitor;
an inductive element that is coupled to the capacitor; and
a switching circuit,
wherein after forming a path from the input power supply to the inductive element and the capacitor to step down energy of the input power supply, the switching circuit charges the capacitor with the stepped down energy, and after forming a path from the capacitor and the inductive element to the LED to step up the energy with which the capacitor is charged, the switching circuit outputs the stepped up energy to the LED.

2. The flash generating device for an LED, according to claim 1, wherein:
the switching circuit has first, second, third, and fourth terminals;
the input power supply is coupled to the first terminal;
the inductive element is coupled between the capacitor and the second terminal;
the LED is coupled to the third terminal;
the fourth terminal is coupled to ground;
the switching circuit forms a first path between the first terminal and the second terminal, forms a second path between the second terminal and the fourth terminal, and forms a third path between the second terminal and the third terminal; and
the inductive element, the first path, and the second path constitute a step-down circuit, and the inductive element, the second path, and the third path constitute a step-up circuit.

3. The flash generating device for an LED, according to claim 2, wherein
the switching circuit makes the first path and the second path complementarily conductive to perform step-down operation together with the inductive element, and makes the second path and the third path complementarily conductive to perform step-up operation together with the inductive element.

4. The flash generating device for an LED, according to claim 3, wherein
the switching circuit blocks the third path while performing the step-down operation, and while performing the step-up operation, blocks the first path.

5. The flash generating device for an LED, according to claim 2, wherein
the second path includes a transistor that is coupled between the inductive element and the ground.

6. The flash generating device for an LED, according to claim 3, wherein
the second path includes a transistor that is coupled between the inductive element and the ground.

7. The flash generating device for an LED, according to claim 4, wherein
the second path includes a transistor that is coupled between the inductive element and the ground.

8. A flash generating method for an LED, the method comprising the steps of:
after forming a path from an input power supply to an inductive element, and further to a capacitor coupled to the inductive element to step down energy of the input power, charging the capacitor with the stepped down energy; and
after forming a path from the capacitor and the inductive element to the LED to step up the energy with which the capacitor is charged, outputting the stepped up energy to the LED.

9. A flash generating device for an LED, the device comprising:
an input power supply;
a capacitor;
a step-down circuit that is coupled between the input power supply and one terminal of the capacitor, and includes an inductive element whose one terminal is coupled to the capacitor; and
a step-up circuit that is coupled between the one terminal of the capacitor and one terminal of the LED, and includes the inductive element,
wherein the inductive element is a constituent element of both of the step-down circuit and the step-up circuit.

10. A flash driving circuit for an LED, the circuit comprising:
a control circuit;
a first transistor whose switching is controlled by a drive signal outputted by the control circuit;
a constant current source that is coupled between the control circuit and ground;
a first terminal that is provided at one terminal of the first transistor and that makes a coupling to an input power supply;
a second terminal that is provided at another terminal of the first transistor and that makes a coupling to a step-up circuit;
a third terminal that controls switching of a second transistor by a drive signal; and
a fourth terminal that couples the constant current source to the LED,
wherein an inductive element whose one terminal is coupled to a capacitor, and the second transistor whose one terminal is coupled to the inductive element and another terminal is coupled to the ground are part of the step-up circuit.

11. The flash generating device for an LED, according to claim 2, wherein
the first path includes a transistor that is coupled between the first terminal and the second terminal.

12. The flash generating device for an LED, according to claim 3, wherein
the first path includes a transistor that is coupled between the first terminal and the second terminal.

13. The flash generating device for an LED, according to claim 4, wherein
the first path includes a transistor that is coupled between the first terminal and the second terminal.

14. The flash generating device for an LED, according to claim 5, wherein
the first path includes a transistor that is coupled between the first terminal and the second terminal.

15. The flash generating device for an LED, according to claim 2, wherein
the third path includes a diode that is coupled between the second terminal and the third terminal.

16. The flash generating device for an LED, according to claim 3, wherein
the third path includes a diode that is coupled between the second terminal and the third terminal.

17. The flash generating device for an LED, according to claim 4, wherein
the third path includes a diode that is coupled between the second terminal and the third terminal.

18. The flash generating device for an LED, according to claim 5, wherein
the third path includes a diode that is coupled between the second terminal and the third terminal.

19. The flash generating device for an LED, according to claim 2, wherein
the third path includes a diode that is coupled between the second terminal and the third terminal.
